(19) United States
(12) Patent Application Publication
(10) Pub. No.: US 2019/0375321 A1
(43) Pub. Date: Dec. 12, 2019

(54) VEHICLE INTERIOR EQUIPMENT

(71) Applicant: TOYOTA BOSHOKU KABUSHIKI KAISHA, Aichi-ken (JP)

(72) Inventor: Komei YANO, Aichi-ken (JP)

(73) Assignee: TOYOTA BOSHOKU KABUSHIKI KAISHA, Aichi-ken (JP)

(21) Appl. No.: 16/434,712

(22) Filed: Jun. 7, 2019

(30) Foreign Application Priority Data
Jun. 11, 2018 (JP) 2018-111274

(51) Int. Cl. B60N 2/66; B60N 2/00; B60N 2/20; A47C 7/14; A47C 7/46

(52) U.S. Cl. CPC B60N 2/667; B60N 2/002; A47C 7/46; A47C 7/14; B60N 2/20

(57) ABSTRACT

A vehicle interior equipment including: a contact portion contactable with a human body; and an outer shape member including: receiving portions; a hinge portion connecting adjacent receiving portions; and an outer or inner side deformable portion, in which a shape of the contact portion is changed to the following (a) or (b) by contraction or extension of the outer or inner side deformable portion: (a) the outer shape of the contact portion being made concave by bending the hinge portion so that the adjacent receiving portions are close to each other on the outer side; and (b) the outer shape of the contact portion being made convex by bending the hinge portion so that the adjacent receiving portions are close to each other on the inner side, and in which the inner or outer side deformable portion maintains the changed outer shape even without contacting with human body.

### CROSS-REFERENCE TO RELATED APPLICATIONS

This application claims priority from Japanese Patent Application No. 2018-111274 filed on Jun. 11, 2018, the entire contents of which are incorporated herein by reference.

### TECHNICAL FIELD

The present disclosure relates to a vehicle interior equipment that includes a contact portion configured to contact with a human body and an outer shape member forming an outer shape of the contact portion, in which the outer shape of the contact portion is configured to be changed by deforming at least a portion of the outer shape member.

### BACKGROUND

A vehicle seat disclosed in JP-A-2009-172145 is known as such a vehicle interior equipment. In this vehicle seat, a seating surface portion where an occupant can be seated corresponds to a contact portion of the disclosure, and is covered with a cover that forms a design surface. An outer shape of the seating surface portion is formed by a pad that elastically supports the occupant and a plurality of airbags corresponding to outer shape members of the disclosure. The plurality of airbags are tubular members elongated in a seat width direction, and can be inflated by being filled with air. In the prior art, after the plurality of airbags are arranged in parallel in a recessed portion provided on a seating side of the pad, the seating side of the pad is covered with the airbags and the cover. Each of the plurality of airbags includes an air passage in communication with an actuator (compressor), and is individually supplied with air from the actuator via the corresponding air passage. In the prior art, by inflating specific airbags, for example, the shape of the seating surface portion can be made uneven according to buttock shapes of the occupant.

In the prior art, when the shape of the seating surface portion (the contact portion) is changed, air is supplied to the airbags by using the actuator and the air passages. Therefore, in a configuration according to the prior art, the number of components increases to complicate the configuration, and space for arranging the actuator and the air passages is essential, so that the entire seat tends to be large.

### SUMMARY

The disclosure has been made in view of the above circumstances, and the problem to be solved by the disclosure is to change the outer shape of the contact portion configured to contact with the human body by a simpler and more compact configuration.

As a means for solving the above problem, a vehicle interior equipment according to an aspect of the disclosure includes: a contact portion configured to contact with a human body; and an outer shape member forming an outer shape of the contact portion, wherein the outer shape of the contact portion is configured to be changed by deforming at least a portion of the outer shape member, the outer shape member including: a plurality of receiving portions capable of receiving the human body; a hinge portion that connects adjacent receiving portions; an outer side deformable portion arranged outward than the hinge portion on an outer side, the outer side being a side of the outer shape member facing the human body; and an inner side deformable portion arranged inward than the hinge portion on an inner side opposite to the outer side, in which the plurality of receiving portions and the hinge portion constitute a frame of the outer shape member, and each of the outer side deformable portion and the inner side deformable portion is a linear or planar portion that is configured to be extended or contracted by external stimulation and is configured to return to an original state by not receiving external stimulation, in which the adjacent receiving portions are connected by the outer side deformable portion and the inner side deformable portion, in which a shape of the outer shape member and a shape of the contact portion are configured to be changed to the following (a) by the contraction of the outer side deformable portion or the extension of the inner side deformable portion that receives the external simulation, and are configured to be changed to the following (b) by the extension of the outer side deformable portion or the contraction of the inner side deformable portion that receives the external simulation: (a) the outer shape of the contact portion being made concave by bending the hinge portion so that the adjacent receiving portions are close to each other on the outer side; and (b) the outer shape of the contact portion being made convex by bending the hinge portion in an opposite direction so that the adjacent receiving portions are close to each other on the inner side, and in which the inner side deformable portion or the outer side deformable portion which is in a contraction state or an extension state is configured to maintain the changed outer shape of the contact portion even without contacting with the human body.

### BRIEF DESCRIPTION OF DRAWINGS

FIG. 1 is a schematic perspective view of a vehicle seat:

FIG. 2 is a schematic top view of a seat cushion;

FIG. 3 is a cross-sectional view of a portion of the seat cushion;

FIG. 4 is a perspective view of a frame portion of an outer shape member excluding a cushion portion;

FIG. 5 is a perspective view of a wire forming each deformable portion;

FIG. 6 is a perspective view of the wire in a contracted state;

FIG. 7 is a schematic cross-sectional view of the seat cushion when seated by a passenger;

FIG. 8 is a side view of the outer shape member deformed into a concave shape:

FIG. 9 is a side view of the outer shape member deformed into a convex shape;

FIG. 10 is a perspective view of another wire according to a first modification:

FIG. 11 is a perspective view of a surface member forming a deformable portion of a second modification:

FIG. 12 is a perspective view of a surface member that spreads in a planar direction;

FIG. 13 is a side view of a portion of an outer shape member according to a second embodiment; and

FIG. 14 is a schematic view of a seat cushion according to the second embodiment.

### DETAILED DESCRIPTION

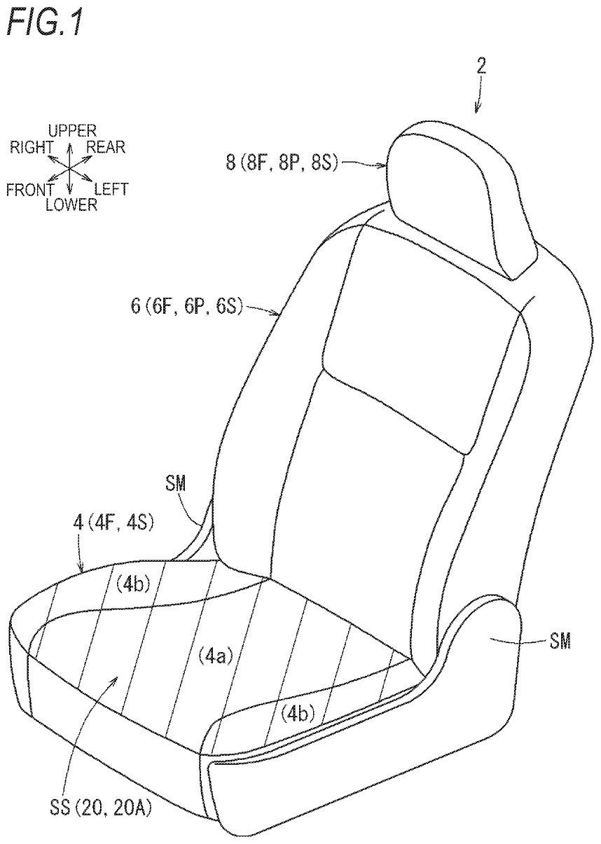

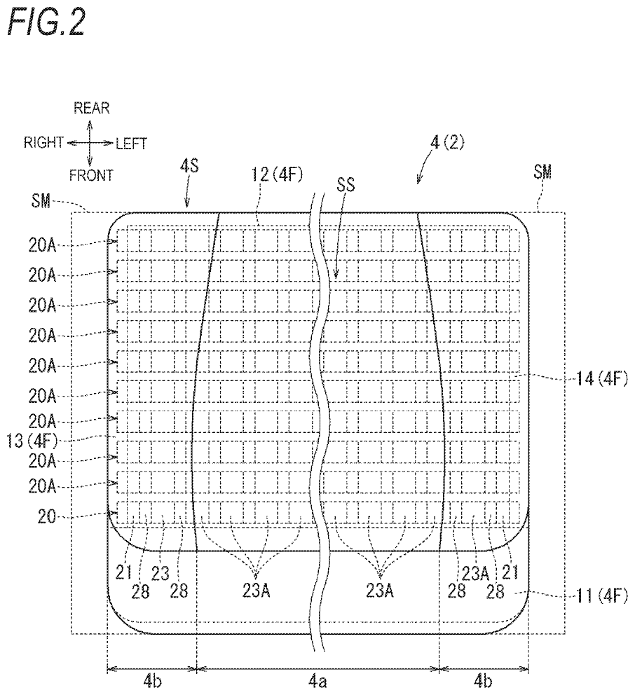

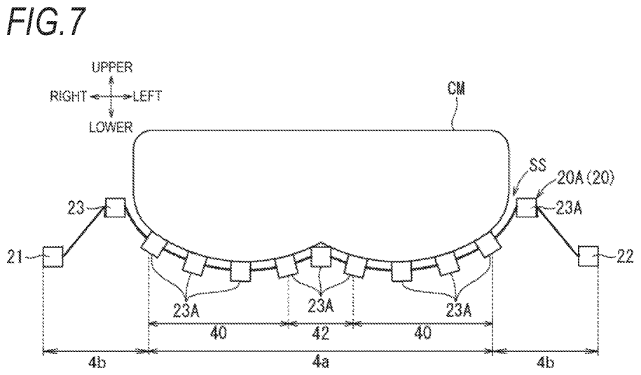

Hereinafter, embodiments of the disclosure will be described with reference to FIGS. 1 to 14. For convenience, arrows lines indicating a front-rear direction, a left-right direction and an upper-lower direction of a vehicle seat are appropriately illustrated in the drawings. In FIG. 1, a seating surface portion as a contact portion is hatched and illustrated for convenience. In FIGS. 2 and 7, an outer shape member and a configuration thereof (a receiving portion and the like) are simplified and only a frame portion is illustrated for convenience. In FIGS. 2 and 7, dimensions of the outer shape member and the configuration thereof are exaggerated and illustrated, and the configuration number and dimensions of the outer shape member and the like may be different from an actual product.

### First Embodiment

A vehicle seat 2 illustrated in FIG. 1 is a member corresponding to a vehicle interior equipment of the disclosure, and includes a seat cushion 4, a seat back 6 and a headrest 8. A lower portion of the seat back 6 is foldably connected to a rear portion of the seat cushion 4 (described below in detail). A headrest 8 is arranged at an upper portion of the seatback 6 in an upright state. The seat components (4, 6 and 8) includes seat frames (4F. 6F and 8F) forming a seat frame, and seat covers (4S, 6S and 8S) forming a design surface of a seat, respectively. The seat back 6 (and the headrest 8) is provided with a seat pad 6P (8P) forming an outer shape to elastically support an occupant, and the seat pad 6P (8P) is covered with a corresponding seat cover 6S (8S).

[Seat Cushion]

The seat cushion 4 is a substantially rectangular member in a top view as illustrated in FIGS. 1 and 2, and includes the above-described basic configurations 4F and 4S as well as a plurality of outer shape members 20 and 20A (details of each member will be described below). An upper surface of the seat cushion 4 serves as a seating surface portion SS where the occupant can be seated, and the seating surface portion SS corresponds to a contact portion of the disclosure. The seating surface portion SS can be divided into a top plate main portion 4a as well as left and right top plate side portions 4b. The top plate main portion 4a is a portion, formed at a center in a seat width direction, where the occupant can be seated. The left and right top plate side portions 4b are portions relatively raised upward at lateral sides of the top plate main portion 4a in a seat width direction (left-right direction).

An outer shape of the seating surface portion SS is formed by a plurality of outer shape members 20 and 20A illustrated in FIG. 2. The plurality of outer shape members 20 and 20A are covered with the seat cover 4S, and include a plurality of receiving portions 21 to 23 (23A) and hinge portions 28 as a frame portion to be described later (reference numerals corresponding only to the receiving portions and the hinge portions of some outer shape members are provided for convenience in FIG. 2). In the embodiment, as described later, arrangement relationship between adjacent receiving portions is changed to deform specific outer shape members 20 and 20A, whereby the outer shape of the seating surface portion SS is configured to be changed into a convex shape or a concave shape in accordance with the physique of the occupant. In such a seat configuration, excessive complication and enlargement of the seat configuration should be avoided as much as possible due to the configuration for changing the outer shape of the seating surface portion SS. Therefore, in the embodiment, the outer shape of the seating surface portion SS as the contact portion is changed by a simpler and more compact configuration described later. Each configuration will be described in detail below.

[Basic Configuration]

Here, as illustrated in FIG. 2, the seat frame 4F is a substantially rectangular frame body as viewed from above, and is formed of a material having excellent rigidity such as a metal or a hard resin. The seat frame 4F includes a front frame portion 11 forming a front side, a rear frame portion 12 forming a rear side, a right frame portion 13 forming a right side, and a left frame portion 14 forming a left side. The front frame portion 11 and the rear frame portion 12 are plate-shaped portions extending respectively in the left-right direction as the seat width direction, and are arranged to face each other at an appropriate interval in the seat front-rear direction. The right frame portion 13 and the left frame portion 14 are plate-shaped portions extending respectively in the seat front-rear direction, and are arranged to face each other at an appropriate interval in the seat left-right direction.

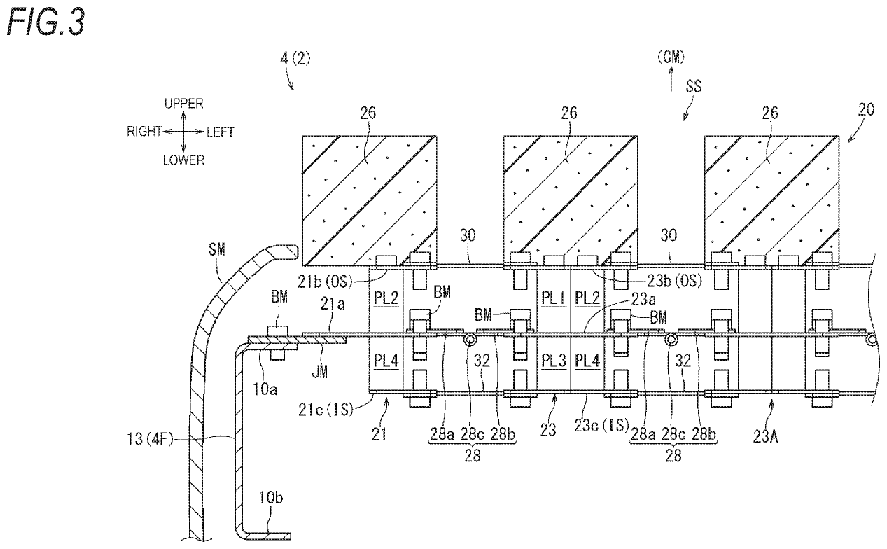

An upper edge and a lower edge of the right frame portion 13 are bent inward a frame of the seat frame 4F as illustrated in FIG. 3, an upper flange portion 10a is formed by the upper edge, and a lower flange portion 10b is formed by the lower edge. The upper flange portion 10a is provided with a plurality of fastening holes (not illustrated) at appropriate intervals, and the outer shape members 20 and 20A described below can be fastened and fixed by bolt members BM inserted into the fastening holes. Similarly to the right frame portion 13, an upper flange portion and a lower flange portion (not illustrated) are also formed in the left frame portion 14 illustrated in FIG. 2, and the outer shape members 20 and 20A described below can be fastened and fixed to the upper flange portion. Outer sides of the right frame portion 13 and the left frame portion 14 of the seat cushion 4 illustrated in FIGS. 1 and 2 is covered with plate-shaped shields SM, and the shield SM can be typically formed of a material having high rigidity such as a hard resin. An outer surface side of the shield SM may be covered with a seat cover that is not illustrated, and the seat cover may also be used as an alternative to the shield SM.

[Outer Shape Member]

In the frame of the seat frame 4F illustrated in FIG. 2, the plurality of outer shape members 20A are arranged in parallel in the front-rear direction (a specific reference numeral 20 is attached to a specific outer shape member and a common reference numeral 20A is attached to the other outer shape members for convenience in FIG. 2). The plurality of outer shape members 20 and 20A are members elongated in the left-right direction, which forms the outer shape of the seating surface portion SS of the seat cushion 4 respectively, and are arranged across the top plate main portion 4a and the top plate side portions 4b. Since the plurality of outer shape members 20 and 20A have substantially the same basic configuration except that arrangement positions in the seat frame 4 are different from each other, details of the outer shape member 20 arranged on the front side of the seat will be described below as an example.

[Receiving Portion]

The outer shape member 20 illustrated in FIGS. 2 and 3 includes the plurality of receiving portions 21 to 23 (23A), a plurality of cushion portions 26, the plurality of hinge portions 28, a plurality of outer side deformable portions 30, and a plurality of inner side deformable portions 32. Here, a frame portion of the outer shape member 20 is constituted by the receiving portions 21 to 23 (23 A) and the hinge portions 28 described below. The plurality of receiving portions 21 to 23 (23A) are portions capable of receiving the occupant, and are arranged at substantially equal intervals in the left-right direction of the outer shape member 20. The plurality of receiving portions can be divided into an end receiving portion 21 (22) arranged at a right end (a left end) and a plurality of intermediate receiving portions 23 and 23A arranged between the left and right end receiving portions 21 (22) (a reference numeral 23 is attached to a specific intermediate receiving portion, and a common reference numeral 23A is attached to the other intermediate receiving portions for convenience in the drawings). The intermediate receiving portions 23 and 23A of the embodiment have substantially the same basic configuration, and the left and right end receiving portions 21 (22) have substantially the same basic configuration except being laterally symmetrical. Therefore, the intermediate receiving portion 23 and the end receiving portion 21 on a right end side will be described in detail as an example (common symbols may be given to members that can be shared by the receiving portions).

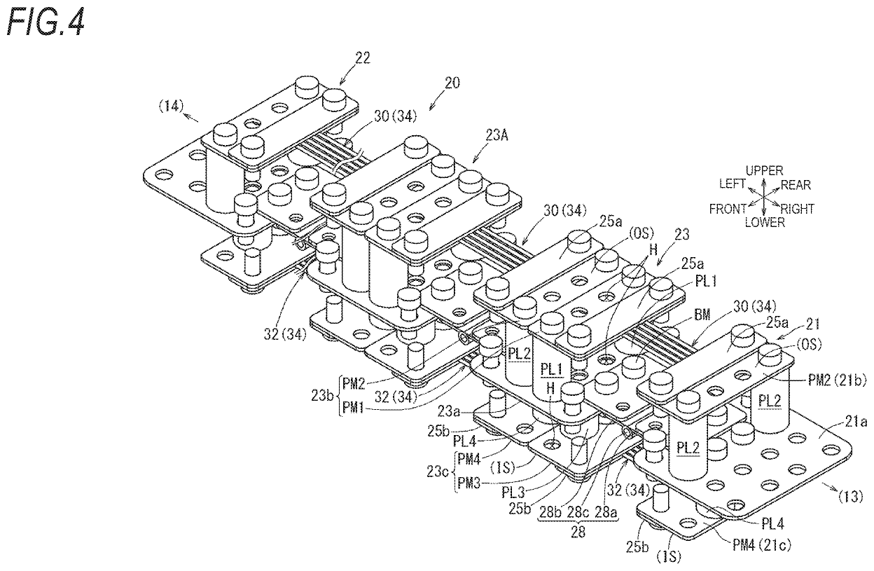

The intermediate receiving portion 23 illustrated in FIGS. 3 and 4 is arranged between the end receiving portion 21 (described in detail below) arranged on the right end side and another intermediate receiving portion 23A arranged on a left side. A frame portion (a portion excluding the cushion portion described below) of the intermediate receiving portion 23 includes a base plate portion 23a, an outer side plate portion 23b, an inner side plate portion 23c, and a plurality of pillar portions PL1 to PL4 that connect the plate portions to each other with reference to FIG. 4. The base plate portion 23a is a substantially square flat plate member as viewed from above, and is arranged at a center of the intermediate receiving portion 23 in the upper-lower direction. The base plate portion 23a is provided with four rows of fastening holes H arranged in the left-right direction, each row including four fastening holes arranged in the front-back direction, and other members can be fastened and fixed to the fastening holes H by inserting the bolt members BM (reference numerals H and BM are attached to some of the fastening holes and bolt members, and illustration of a nut screwed to the bolt member is omitted, for convenience in the drawings). The pillar portions PL1 to PL 4 and the hinge portions 28 (described below in detail) are respectively fastened and fixed to appropriate positions of the base plate portion 23a.

The outer side plate portion 23b illustrated in FIG. 4 is a flat plate-shaped portion forming an outer side surface OS (an upper surface in FIG. 4) facing the occupant on the intermediate receiving portion 23, and a plurality of fastening holes H are provided corresponding to the base plate portion 23a. Flat outer hold plates 25a are respectively fastened and fixed to left and right edges of the outer side plate portion 23b (the outer side surface OS), and the outer side deformable portions 30 described below are configured to be attached to the intermediate receiving portion 23 by the outer hold plates 25a. The outer side plate portion 23b is constituted by a pair of left and right outer plate members PM1 and PM2, and each outer plate member PM1 (PM2) is a rectangular plate member long in the front-rear direction, and is fastened and fixed to a pair of outer side pillar portions PL1 (PL2) protruding upward from the base plate portion 23a. That is, the right outer plate member PM1 is supported by front and rear ends of a left edge thereof respectively being fastened and fixed to the outer side pillar portions PL1, and the left outer plate member PM2 is supported by front and rear ends of a right edge thereof being fastened and fixed to the outer side pillar portions PL2.

The inner side plate portion 23c illustrated in FIG. 4 is a flat plate-shaped portion forming an inner side surface IS (a lower surface in FIG. 4) of the intermediate receiving portion 23 opposite to an outer surface, and a plurality of fastening holes H are provided corresponding to the base plate portion 23a. Flat inner hold plates 25b are respectively fastened and fixed to left and right edges of the inner side plate portion 23c (the inner side surface IS), and the inner side deformable portions 32 described below are configured to be attached to the intermediate receiving portion 23 by the inner hold plates 25b. The inner side plate portion 23c is constituted by a pair of left and right inner plate members PM3 and PM4, and each inner plate member PM3 (PM4) is a rectangular plate member long in the front-rear direction, and is fastened and fixed to a pair of inner side pillar portions PL3 (PL4) protruding downward from the base plate portion 23a. That is, the right inner plate member PM3 is supported by a center portion of a left edge thereof being fastened and fixed to the inner side pillar portions PL3, and left inner plate member PM4 is supported by a center portion of a right edge thereof being fastened and fixed to the inner side pillar portions PL4.

The end receiving portion 21 on the right end side illustrated in FIGS. 3 and 4 includes another base plate portion 21a as a basic configuration similar to that of the intermediate receiving portion 23, but another outer side plate portion 21b and another inner side plate portion 21c are provided only on a left side facing the intermediate receiving portion 23. That is, the other base plate portion 21a of the end side receiving portion 21 is a substantially square flat plate member as viewed from above, and has substantially the same shape and size as that of the base plate portion 23a of the intermediate receiving portion 23. The other outer side plate portion 21b is constituted by only the outer plate member PM2 arranged directly above a left outer surface (a left upper surface in each drawing) of the base plate portion 21a. The outer hold plate 25a is fastened and fixed only to a left edge of the other outer side plate portion 21b that is further fastened and fixed to a pair of outer side pillar portions PL2 on the base plate portion 21a. The other inner side plate portion 21c is constituted by only the inner plate member PM3 arranged directly below a left inner surface (a left lower surface in each drawing) of the base plate portion 21a. The inner hold plate 25b is fastened and fixed only to a left edge of the other inner side plate portion 21c that is further fastened and fixed to a pair of inner side pillar portions PL4 below the base plate portion 21a.

[Cushion Portion]

With reference to FIG. 3, the outer surface OS of each of the receiving portions 21 to 23 (23A) is provided with a cushion portion 26 that is a portion capable of elastically supporting the occupant. Examples of a material of such a cushion portion 26 may include a foamed resin such as a polyurethane foam, an elastomer having rubber elasticity, a rubber, and a bag material filled with air or gas. The cushion portion 26 of the embodiment is a columnar portion made of a foamed resin, and is attached in a state of being erected on the outer surface OS side of each of the receiving portions 21 to 23 (23A). When the occupant is seated, which will be described below, the cushion portion 26 of each of the receiving portions 21 to 23 (23A) is configured to receive the occupant while bending downward. A method of attaching the cushion portion to each receiving portion is not particularly limited, and for example, a method such as adhesion or fusion can be exemplified, and the cushion portion can also be attached via a fastener such as a bolt member.

[Hinge Portion]

The plurality of hinge portions 28 illustrated in FIGS. 2 to 4 are portions forming the frame portion of the outer shape member 20, and adjacent receiving portions are connected to each other by the hinge portions 28 (the hinge portions are denoted by a common reference numeral 28 in each drawing for convenience, and only some hinge portions are denoted by reference numerals in FIG. 2). The hinge portions 28 are arranged in the outer shape member 20 so as to fill between adjacent receiving portions, and have substantially the same basic configuration. For example, the hinge portion 28 arranged between the right side receiving portions 21 and 23 illustrated in FIGS. 3 and 4 is a metal hinge-like portion, and includes a first connection member 28a on a right side, a second connection member 28b on a left side and a hinge member 28c. Each of the first connection member 28a and the second connection member 28b is a substantially rectangular plate member elongated in the front-rear direction as viewed from above, and a plurality of fastening holes (not illustrated) corresponding to corresponding base plate portions are provided on a right edge of the first connection member 28a and a left edge of the second connection member 28b, respectively. The hinge member 28c is a metal shaft member extending in the front-rear direction, and is capable of bendably connecting the first connection member 28a and the second connection member 28b. That is, the hinge member 28c is arranged between the first connection member 28a and the second connection member 28b, and tubular edge sides of the connection members 28a and 28b are rotatably attached around a shaft of the hinge member 28c. One of the connection members 28a and 28b is configured to be bent upward or downward with respect to the other, by the first connection member 28a and the second connection member 28b rotating relative to each other about the hinge member 28c. In the embodiment, the hinge member 28c is arranged on a lower side, so that excessive rotation of the connection members 28a and 28b when a large load is input is restricted.

[Formation of Frame Portion of Outer Shape Member]

In the embodiment, the first connection member 28a is fixed to one of adjacent receiving portions, and the second connection member 28b is fixed to the other of the adjacent receiving portions, with reference to FIGS. 3 and 4. For example, a left edge of the base plate portion 21a of the end receiving portion 21 is fastened and fixed to a right edge of the first connection member 28a via the bolt member BM. A right edge of the base plate portion 23a of the intermediate receiving portion 23 is fastened and fixed to a left edge of the second connection member 28b via the bolt member BM. The intermediate receiving portion 23 and the end receiving portion 21 is configured to be bent upward or downward together with corresponding connection members about the hinge member 28c. The frame portion of the outer shape member 20 can be constituted by connecting other receiving portions 22 and 23A with corresponding hinge portions 28 in the same procedure.

[Deformable Portion]

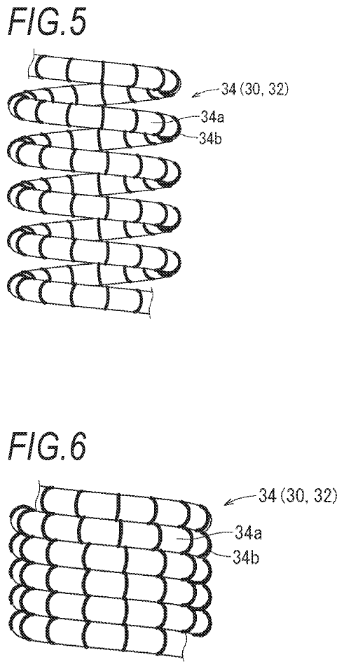

The outer side deformable portion 30 and the inner side deformable portion 32 illustrated in FIGS. 3 and 4 are portions that is respectively extended and contracted by external stimulation described below and return to an original state by not receiving external stimulation. The outer side deformable portion 30 and the inner side deformable portion 32 connect adjacent receiving portions at appropriate positions. Each of the deformable portions 30 and 32 of the embodiment is a substantially linear portion connecting adjacent receiving portions, and includes a stretchable wire 34 (described below in detail) illustrated in FIG. 5. Here, each of the deformable portions 30 and 32 can be constituted only by the wire 34, and a reinforcement member (not illustrated) can also be used as necessary. For example, rigidity of the deformable portions 30 and 32 can be increased by attaching the wire 34 to a reinforcement member having appropriate stretchability by a method such as sewing. As a such reinforcement member, various planar or linear members that is extended or contracted following extension or contraction of the wire 34 described below can be used, and for example, a belt-like planar member made of fabric or a linear member having rubber elasticity can be exemplified. Although the number of the wires 34 used for each of the deformable portions 30 and 32 is not particularly limited, a plurality of wires 34 can be used from the viewpoint of ensuring rigidity and the like. For example, the plurality of wires 34 can be twisted or aligned to form linear deformable portions 30 and 32, and the plurality of wires 34 (warp) and other yarn materials (weft) can be woven to form plain-woven belt-like deformable portions 30 and 32.

[Wire]

The wire 34 illustrated in FIGS. 5 and 6 is a linear member functioning as a soft actuator (artificial muscle), and is configured to contract under thermal stimulation (an example of external stimulation). The wire 34 includes a first wire 34a serving as an essential component and a second wire 34b serving as an attached component. The first wire 34a is a linear member extending in an axial direction in a coil shape, and is formed of a polymer that is contracted in an entire length and is extended in diameter when heated in a stretched state. The coil shape of the first wire 34a is formed by twisting the first wire 34a arranged in a straight line, and the coil shape that can be naturally generated by twisting is adopted. A material of the first wire 34a is not particularly limited as long as the material has desired characteristics, and various polymer fibers can be used, for example. A polymer fiber made of a polyamide resin such as nylon 6 and nylon 6, 6, a polymer fiber made of a polyester resin such as polyethylene terephthalate, and polymer fibers made of various resins having the same properties as those described above can be suitably used as such a polymer fiber. The second wire 34b is a linear member that generates heat when energized, and is spirally wound around the first wire 34a. As a material of such a second wire 34b, various materials having conductivity can be used, and a yarn material such as a metal (copper, aluminum and the like) or an alloy, a plated wire, or a carbon fiber filament can be used. The plated wire has a non-conductive or conductive core material and a coating layer made of metal or alloy plating. Carbon fibers are polyacrylonitrile-based carbon fibers (PAN-based carbon fibers) and pitch-based carbon fibers. When the wire 34 can be directly heated by warm air of a blowing device installed on a seat, a surface heater or the like, the wire 34 can be formed only by the first wire 34a.

[Arrangement of Deformable Portions with Respect to Outer Shape Member]

Adjacent receiving portions are connected to each other at appropriate positions by the plurality of outer side deformable portions 30 and the plurality of inner side deformable portions 32 with reference to FIGS. 3 and 4 (reference numerals indicating all the deformable portions are attached to the plurality of deformable portions in each drawing for convenience). Here, since a method of arranging the deformable portions 30 and 32 with respect to the receiving portions is substantially the same, the end side receiving portion 21 on the right end side and the intermediate receiving portion 23 will be described in detail below as an example. When the outer side deformable portion 30 is arranged, a right end of the outer side deformable portion 30 is sandwiched between the outer surface OS of the end side receiving portion 21 and the outer hold plate 25a, and a left end of the outer side deformable portion 30 is sandwiched between a right side of the outer surface OS of the intermediate receiving portion 23 and the outer hold plate 25a. In this way, the outer side deformable portion 30 is arranged so as to connect the adjacent receiving portions 21 and 23 in a state where the outer side deformable portion 30 is arranged outward than the hinge portion 28 (on an upper side in each drawing). When the inner side deformable portion 32 is arranged, a right end of the inner side deformable portion 32 is sandwiched between the inner surface IS of the end side receiving portion 21 and the inner hold plate 25b, and a left end of the inner side deformable portion 32 is sandwiched between a right side of the inner surface IS of the intermediate receiving portion 23 and the inner hold plate 25b. In this way, the inner side deformable portion 32 is arranged so as to connect the adjacent receiving portions 21 and 23 in a state where the inner side deformable portion 32 is arranged inward than the hinge portion 28 (on a lower side in each drawing). The outer shape member 20 can be constituted by connecting the other receiving portions 22 and 23A illustrated in FIG. 2 with corresponding deformable portions 30 and 32 in the same procedure.

[Arrangement of Outer Shape Member]

The left and right end side receiving portions 21 (22) are respectively fixed to the seat frame 4F while the outer shape members 20 and 20A are arranged in the frame of the seat frame 4F with reference to FIGS. 2 and 3. For example, in the end side receiving portion 21 on the right end side illustrated FIG. 3, a connection plate JM is fastened and fixed to a right edge of the base plate portion 21a, and is fastened and fixed to the upper flange portion 10a of the right frame portion 13 via the bolt member BM. Similarly, the end side receiving portion 22 on a left end side illustrated in FIG. 2 is also fastened and fixed to the left frame portion 14 via a connection plate (not illustrated). In this state, a plurality of intermediate receiving portions 23 and 23A are arranged between the left and right end receiving portions 21 and 22, and the receiving portions 21 to 23 (23A) are arranged in a state of being bridged in a left-right direction in the frame of the seat frame 4F. After the outer shape members 20 are arranged in the seat frame 4 F in this way, the seat cover 4S illustrated in FIG. 2 covers outside thereof, thereby forming the seating surface portion SS as the contact portion. In the outer shape members 20 and 20A in a free state, tensions of the deformable portions 30 and 32 illustrated in FIG. 3 are evenly applied between the receiving portions, so that the hinge portions 28 are maintained in a non-bent state.

The seating surface portion SS can be divided into a plurality of portions (left and right strong pressing portions 40 and a weak pressing portion 42) illustrated in FIG. 7 in accordance with degree of pressing received from the occupant, and corresponding receiving portions 22 are respectively arranged in the pressing portions. Here, the left and right strong pressing portions 40 are portions of the seating surface portion SS that supports buttocks and legs of an occupant CM. The left and right strong pressing portions 40 are portions where pressure received from the occupant CM is large, and are arranged separately on left and right sides of the top plate main portion 4a. The weak pressing portion 42 is a portion where the pressure received from the occupant CM is relatively small, and in the embodiment, is provided at a center of the top plate main portion 4a and is arranged between the left and right strong pressing portions 40.

[Method for Energizing Deformable Portions]

Before and after the above-described operation, the wire 34 (the second wire 34b) of the deformable portions 30 and 32 illustrated in FIG. 5 is electrically connected to a power supply (not illustrated) through a wiring or the like. In this way, the second wire 34b is energized as necessary to generate heat, and the first wire 34a is configured to be contracted by the heat generated by the second wire 34b. At this time, the deformable portions 30 and 32 of the outer shape members 20 and 20A may be uniformly energized and contracted, or only a specific deformable portion may be greatly contracted (selectively energized). For example, in selective energization, a deformable portion to be contracted is selected, and only the selected deformable portion is energized. Since the wire 34 of the deformable portions 30 and 32 is contracted greatly as an applied voltage increases, it is possible to select a deformable portion where a large contraction amount is desired and to increase the voltage applied to the selected deformable portion. For example, in the embodiment, as illustrated in FIG. 7, the deformable portions of the outer shape members 20 and 20A arranged in the strong pressing portions 40 and the deformable portions of the outer shape members 20 and 20A arranged at the weak pressing portion 42 can be individually energized. When the selective energization is performed, a selection device (not illustrated) is arranged at or near the vehicle seat 2, and only a specific deformable portion can be energized (or a voltage amount is set) by manually operating the selection device. A sensor (not illustrated) capable of sensing occupant information such as pressure may be arranged in or near the receiving portions 21 to 23 (23 A). The occupant information from the sensor may be transmitted to a control unit (not illustrated) such as an ECU, and the control unit may be configured to automatically energize the specific deformable portion (or set the voltage amount).

[Behavior of Seat Cushion]

When the occupant CM is seated on the seat cushion 4, the occupant CM is received at the seating surface portion SS forming the contact portion with reference to FIGS. 2 and 7. At this time, depending on physique of the occupant CM, the top plate main portion 4a of the seating surface portion SS is partially strongly pressed (seating pressure distribution occurs), and particularly the left and right strong pressing portions 40 are relatively strongly pressed by buttocks and legs of the occupant CM. Since the seating pressure distribution of the seating surface portion SS varies depending on the physique of the occupant CM, a shape of the seating surface portion SS can be preferably changed depending on the physique of the occupant CM. For example, since the left and right strong pressing portions 40 are pressed more strongly than the weak pressing portion 42, concave shapes are preferably formed to be relatively recessed downward. In such a seat configuration, an outer shape of the seating surface portion SS is preferably changed in a relatively simple and compact configuration. In the embodiment, since most of the outer shape of the strong pressing portions 40 is formed by the outer shape members 20A, 20A (20) may be used as a reference numeral indicating the outer shape members in the following description.

Here, the outer shape of the seating surface portion SS of the embodiment is formed by a plurality of outer shape members 20A (20) with reference to FIGS. 2 and 7. Each of the outer shape members 20A (20) includes the plurality of receiving portions 21 to 23 (23 A) capable of receiving a human body, the hinge portions 28 connecting adjacent receiving portions, outer side deformable portions 30 and the inner side deformable portions 32. The plurality of receiving portions 21 to 23 (23A) and the hinge portions 28 constitute a frame of each outer shape member 20A (20). Each of the outer side deformable portion 30 and the inner side deformable portion 32 is a linear or planar portion that is configured to be contracted by external stimulation and is configured to return to an original state by not receiving external stimulation.

Therefore, in the embodiment, with reference to FIGS. 3 and 4, when a side of each outer shape member 20A (20) facing the human body is an outer side, the adjacent receiving portions are connected by the outer side deformable portion 30 arranged outward than the hinge portion 28 on the outer side, and are connected by the inner side deformable portion 32 arranged inward than the hinge portion 28 on an inner side opposite to the outer side. The shape of the outer shape members 20A (20) and the shape of the seating surface portion SS are configured to be changed to the following (a) and (b) by the contraction of the outer side deformable portion 30 or the inner side deformable portion 32 that receives the external stimulation. The inner side deformable portion 32 or the outer side deformable portion 30 in a contracted state maintains the changed outer shape of the seating surface portion SS even without contacting with the human body. That is, in (a), the outer shape of the seating surface portion SS is made concave by bending the hinge portion 28 so that the adjacent receiving portions are close to each other on the outer side. In (b), the outer shape of the seating surface portion SS is made convex by bending the hinge portion 28 in an opposite direction so that the adjacent receiving portions are close to each other on the inner side.

[Example of Changing Shape to (a)]

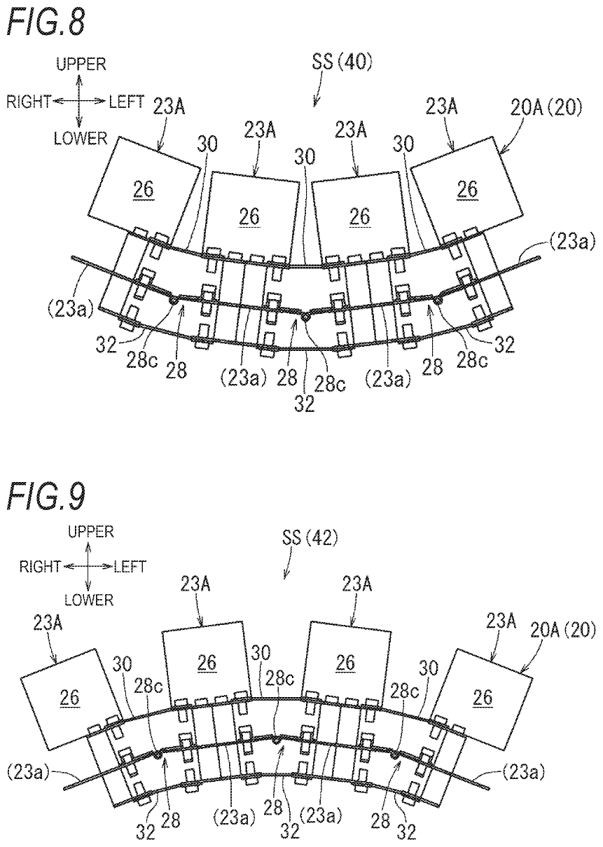

In the left and right strong pressing portions 40 illustrated in FIG. 7, the outer shape of the seating surface portion SS is preferably deformed into concave shapes. Therefore, in the outer shape member 20A (20) illustrated in FIG. 8, by the contraction of the outer side deformable portion 30 that receives external stimulation, each hinge portions 28 is bent and the adjacent receiving portions 23A are brought close to each other on the outer side (the upper side). At this time, the adjacent receiving portions 23A are arranged in a substantially inverse V-shape by inclining toward each other on the outer side (the upper side) about the hinge member 28c of each hinge portion 28. The lengths of the outer shape members 20A (20) illustrated in FIG. 2 in the left-right direction are shorter on the outer side than those on the inner side, so that the outer shape of the strong pressing portions 40 of the seating surface portion SS can be deformed into concave shapes. At this time, since the frame portion of the outer shape member 20A (20) relatively firmly connects the adjacent receiving portions 23A to each other by the metal hinge portions 28, appropriate strength can be ensured even after the shape is changed. Therefore, even if an unexpected large load is input to the seating surface portion SS, the load can be received as much as possible at the frame portion of each outer shape member 20A (20).

[Example of Changing Shape to (b)]

In the weak pressing portion 42 illustrated in FIG. 7, the outer shape of the seating surface portion SS is preferably deformed into a convex shape. Therefore, in the outer shape member 20A (20) illustrated in FIG. 9, by contraction of the inner side deformable portion 32 that receives external stimulation, each hinge portion 28 is bent in the opposite direction and the adjacent receiving portions 23A are brought close to each other on the inner side (the lower side). At this time, the adjacent receiving portions 23A are arranged in a substantially V-shape by inclining toward each other on the inner side (the lower side) about the hinge member 28c of each hinge portion 28. The lengths of the outer shape members 20A (20) illustrated in FIG. 2 in the left and right direction are shorter on the inner side than those on the outer side, so that the outer shape of the weak pressing portion 42 of the seating surface portion SS can be deformed into a convex shape.

In the embodiment, in the top plate side portions 4b illustrated in FIG. 7, the outer shape of the seating surface portion SS can be deformed into a relatively large convex shape by deforming the outer shape members 20A (20). That is, in the outer shape member 20A (20) illustrated in FIG. 9, by contraction of the inner side deformable portion 32 that receives external stimulation, each hinge portion 28 is bent in the opposite direction and the adjacent receiving portions 23A and the like are brought closer to each other on the inner side. In this way, the top plate side portions 4b are shaped to be raised upward as compared with the top plate main portion 4a, and sides of the occupant CM can be appropriately supported by the top plate side portions 4b during cornering traveling or the like.

Accordingly in the embodiment, each outer shape member 20A (20) has an uneven shape that follows the buttocks and the like of the occupant CM, and the surface shape of the seating surface portion SS can be deformed into a seating surface shape that follows the occupant CM. The strong pressing portions 40 and the weak pressing portions 42 are formed in a planar manner in the front-rear and left-right directions which are surface directions of the seating surface portion SS. Therefore, in the strong pressing portions 40 and the weak pressing portion 42, the outer shape members 20A (20) arranged in parallel in the front-rear direction illustrated in FIG. 2 are appropriately deformed into a concavo-convex shape. Since extension and contraction operations of the deformable portions 30 and 32 are performed substantially silently, deterioration of seat performance due to generation of noise can be preferably avoided. The inner side deformable portion 32 or the outer side deformable portion 30 in the contracted state maintains a deformed state of the outer shape members 20A (20) even without contacting with the occupant.

When the occupant CM is seated on the seat cushion 4 illustrated in FIG. 7, since the surface shape of the seating surface portion SS is deformed in advance into the seating surface shape that follows the occupant CM, the occupant CM can be appropriately received and supported. The cushion portions 26 illustrated in FIG. 3 are provided on the outer side of the outer shape members 20A (20), and the occupant CM can be received and elastically supported by the cushion portions 26. Accordingly in the embodiment, the outer shape of the seating surface portion SS is formed by the outer shape members 20A (20), whereby a seat surface shape that follows a wide range of occupants can be formed with a simpler configuration. When the occupant CM leaves the seat, the seating surface portion SS naturally returns to the original state by stopping the energization of the deformable portions 30 and 32 to return to the original state.

As described above, in the embodiment, the outer shape members 20 and 20A are provided therein with the outer side deformable portions 30 and the inner side deformable portions 32 that are contracted in response to the external stimulation, and by contraction of the deformable portions 30 and 32, arrangement of the adjacent receiving portions 21 to 23 (23A) is configured to be changed and arrangement relationship thereof is configured to be maintained as in the above-described in (a) or (b). Since the outer shape of the seating surface portion SS is changed to the convex shape or the concave shape by the deformation of the outer shape members 20 and 20A, configurations other than the outer shape member 20 and 20A can be omitted as much as possible, and a configuration of the vehicle seat 2 can be simplified and made compact. Particularly in the embodiment, since the outer shape members 20 and 20A are operated by electricity or heat as the external stimulation, an actuator (compressor) or an air passage as in the prior art is not required, which contributes to a simplified seat configuration.

In the embodiment, at least a portion of the deformable portions 30 and 32 is formed by the wire 34 that is deformed by the external stimulation, so that the outer shape members 20 and 20A can be more reliably deformed. In the embodiment, the adjacent receiving portions 21 to 23 (23A) are relatively firmly connected by the metal hinge portions 28, so that strength of the outer shape members 20 and 20A can be further improved. The outer shape members 20 and 20A of the embodiment is capable of elastically receiving and supporting a human body (occupant CM) by the cushion portions 26, and is a configuration that can provide excellent cushioning feeling. Therefore, according to the embodiment, the outer shape of the contact portion (seating surface portion SS) that can contact with the human body can be changed by the simpler and more compact configuration.

### First Modification

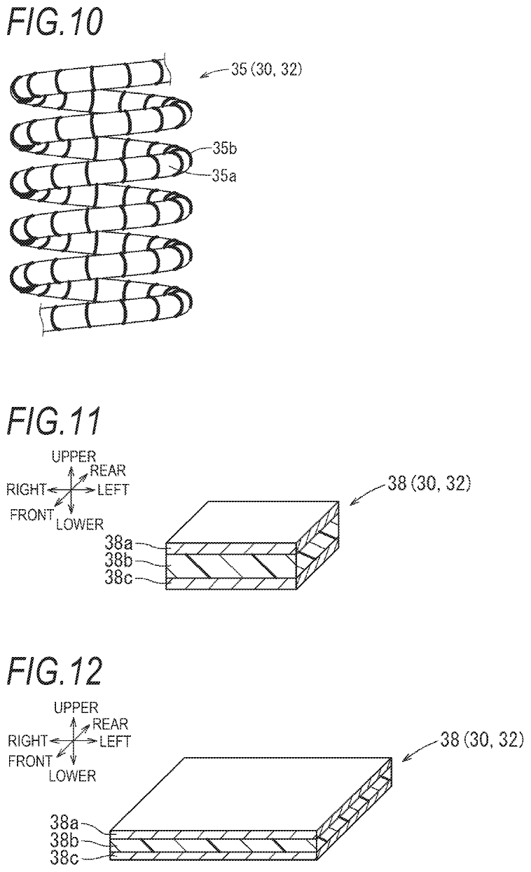

Here, the deformable portion may have various configurations in addition to the above configuration. For example, in a first modification, the outer side deformable portion 30 and the inner side deformable portion 32 illustrated in FIG. 3 includes another wire 35 illustrated in FIG. 10. The other wire 35 has substantially the same configuration (another first wire 35a and another second wire 35b) as that in the first embodiment. In the modification, a coil shape of the other first wire 35a is formed by twisting the other first wire 35a arranged in a straight line, and a coil shape in a direction opposite to the coil shape that can be naturally generated by twisting is adopted. The other first wire 35a having the coil shape in the opposite direction can be extended by heating in a direction opposite to that of the wire in the first embodiment.

In the modification, another wire 35 illustrated in FIG. 10 is used as an alternative to the wire in the first embodiment for the deformable portions 30 and 32 illustrated in FIGS. 3 and 4. The shape of the outer shape members 20A (20) and the shape of the seating surface portion SS are configured to be changed to the above-described (a) or (b) by the extension of the outer side deformable portion 30 or the inner side deformable portion 32 that receives external stimulation. For example, in the strong pressing portions 40 illustrated in FIG. 7, the outer shape of the seating surface portion SS is deformed into concave shapes by deforming corresponding outer shape members 20A (20). At this time in the modification, in the outer shape member 20A (20) illustrated in FIG. 8, by the extension of the inner side deformable portion 32 (the other wire 35) that receives external stimulation, each hinge portion 28 is bent and the adjacent receiving portions 23A are brought close to each other on the outer side (the upper side). Accordingly in the modification as well, the lengths of the outer shape members 20A (20), arranged in parallel in the front-rear direction in FIG. 2, in the left-right direction are shorter on the outer side than those on the inner side, so that the outer shape of the strong pressing portions 40 of the seating surface portion SS can be deformed into concave shapes.

In the weak pressing portion 42 (and the top plate side portions 4b) illustrated in FIG. 7, the outer shape of the seating surface portion SS is deformed into a convex shape by deforming corresponding outer shape members 20A (20). In the modification, in the outer shape member 20A (20) illustrated in FIG. 9, by the extension of the outer side deformable portion 30 (the other wire 35) that receives external stimulation, each hinge portion 28 is bent in the opposite direction and the adjacent receiving portions 23A are brought close to each other on the inner side (the lower side). In the modification as well, the lengths of the outer shape members 20A (20), arranged in parallel in the front-rear direction in FIG. 2, in the left and right direction are shorter on the inner side than those on the outer side, so that the outer shape of the weak pressing portion 42 of the seating surface portion SS can be deformed into a convex shape.

[Second Modification (Surface Member Made of Dielectric Elastomer)]

In a second modification, the outer side deformable portion 30 and the inner side deformable portion 32 illustrated in FIG. 3 each includes a surface member 38 made of a dielectric elastomer illustrated in FIGS. 11 and 12. The surface member 38 is a planar member having a multilayer structure, and functions as a soft actuator (artificial muscle) in the same manner as the wire in the first embodiment. With reference to FIG. 12, the surface member 38 can spread in a planar direction (front-rear and left-right directions in FIG. 12) by receiving electrical stimulation (an example of external stimulation), and a front side electrode portion 38a, a main body portion 38b and a back side electrode portion 38c are provided in this order in a laminated form. Here, the main body portion 38b can be formed of various dielectric elastomers that are thinned and spread in the planar direction by receiving electrical stimulation. Examples of a base material of such dielectric elastomers include various kinds of elastomers such as acrylic-based, urethane-based, silicon-based and styrene-based, and the main body portion 38b can be formed by containing a conductive filler in these various base materials. Here, the conductive filler is a fine substance having conductivity, and examples of such conductive fillers may include metal sheets or metal particles such as gold, platinum, silver and copper, carbon-based fine particles and fibers, and carbon nanotubes. Each of the electrode portions 38a and 38c is a planar member having appropriate conductivity, and the electrode portions 38a and 38c preferably have stretchability that can follow spread of the main body portion 38b in the planar direction. Examples of a base material of such electrode portions 38a and 38c may include a base material exemplified by a dielectric elastomer, and a resin such as a highly viscous material such as a silicone grease. The electrode portions 38a and 38c can be formed by containing a conductive filler in various base materials, and at this time, conductivity is preferably increased by containing a larger amount of conductive filler than that of the main body portion 38b.

In the modification, the surface member 38 illustrated in FIG. 11 is used as an alternative to the wire in the first embodiment for the deformable portions 30 and 32 illustrated in FIGS. 3 and 4. By spread and extension, in the planar direction, of the outer side deformable portion 30 or the inner side deformable portion 32 that receives external stimulation, the shape of the outer shape members 20A (20) and the seating surface portion SS is configured to be changed to the above-described (a) or (b). For example, in the right and left strong pressing portions 40 illustrated in FIG. 7, the outer shape of the seating surface portion SS is deformed into concave shapes by deforming corresponding outer shape members 20A (20). At this time in this modification, in the outer shape member 20A (20) illustrated in FIG. 8, by the extension of the inner side deformable portion 32 (the surface member 38) that receives external stimulation, each hinge portion 28 is bent and the adjacent receiving portions 23A are brought close to each other on the outer side (upper side). Accordingly in the modification as well, the lengths of the outer shape members 20A (20), arranged in parallel in the front-rear direction illustrated in FIG. 2, in the left-right direction are shorter on the outer side than those on the inner side, so that the outer shape of the strong pressing portions 40 of the seating surface portion SS can be deformed into concave shapes.

In the weak pressing portion 42 (and the top plate side portions 4b) illustrated in FIG. 7, the outer shape of the seating surface portion SS is deformed into a convex shape by deforming corresponding outer shape members 20A (20). In the modification, in the outer shape member 20A (20) illustrated in FIG. 9, by the extension of the outer side deformable portion 30 (the surface member 38) that receives external stimulation, each hinge portion 28 is bent in the opposite direction and the adjacent receiving portions 23A are brought close to each other on the inner side (the lower side). Accordingly in the modification as well, the lengths of the outer shape members 20A (20), arranged in parallel in the front-rear direction illustrated in FIG. 2, in the left-right direction are shorter on the inner side than those on the outer side, so that the outer shape of the weak pressing portion 42 of the seating surface portion SS can be deformed into a convex shape.

[Function as Sensor]

The surface member 38 made of the dielectric elastomer illustrated in FIGS. 11 and 12 can also function as a capacitance type sensor since the front side electrode portion 38a, the main body portion 38b and the back side electrode portion 38c are laminated. Therefore, in this modification, capacitance distribution of the seating surface portion SS when the occupant is seated is measured by the surface member 38, the measurement information is transmitted to a control unit (not illustrated) such as an ECU. The control unit may be configured to automatically energize the inner side deformable portion 32 (the surface member 38) or the like of the seat surface portion SS that is relatively strongly pressed. Therefore, according to this modification, use of a separate sensor is not necessary, which contributes to a more simplified seat configuration. In this way, by forming at least one of the deformable portions 30 and 32 with the surface member 38 made of the dielectric elastomer that can also be used for the sensor, the outer shape members 20A (20) can be deformed with higher performance.

### Second Embodiment

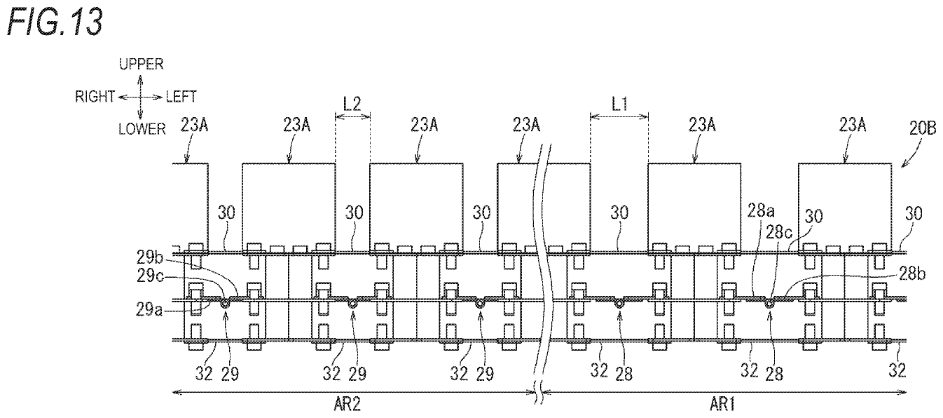

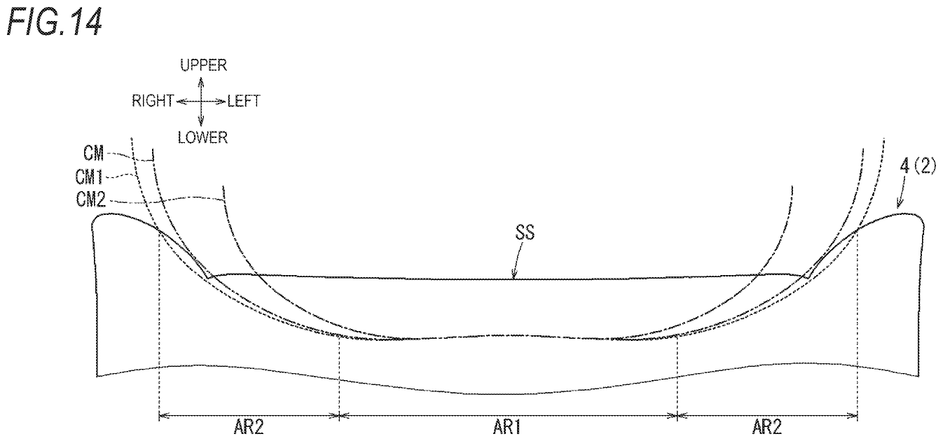

In a vehicle seat of a second embodiment, a configuration including a basic configuration same as that of the vehicle seat in the first embodiment is denoted by corresponding reference numerals and a detailed description thereof will be omitted. In the vehicle seat of the second embodiment, outer shape members 20B illustrated in FIG. 13 are arranged in parallel in the front-rear direction so as to form an outer shape of the seating surface portion SS illustrated in FIG. 14. The outer shape member 20B in FIG. 13 includes a plurality of receiving portions 23A, a plurality of hinge portions 28 and 29, a plurality of outer side deformable portions 30 and a plurality of inner side deformable portions 32, and a basic configuration of the portions is substantially the same as the corresponding configuration of the outer shape member in the first embodiment. The second embodiment is different from the first embodiment in that a distance L2 between the receiving portions 23A on right and left sides in the left-right direction illustrated in FIG. 13 is smaller than a distance L1 between the receiving portions 23A arranged on a center side (FIG. 13 illustrates only the receiving portions on the right side for convenience).

Here, in the seat cushion 4 illustrated in FIG. 14, an occupant CM having an average physique, an occupant CM1 having a large physique and an occupant CM2 having a small physique are assumed to be seated. At this time, a high seating pressure is applied at a center of the seat no matter what physique occupant is seated, so that a shape of the seating surface portion SS in a central area (AR1) thereof is substantially the same. Differently, in left and right end areas (AR2) of the seating surface portion SS, pressure applied according to the physique of the occupant is different, and area of a concave portion gradually becomes larger as the physique becomes larger. Therefore, the shape of the left and right end areas (AR2) of the seating surface portion SS preferably can be finely changed so as to be adapted to any one of the occupants having different physiques.

Therefore, in the outer shape member 20B illustrated in FIG. 13, the distance L2 between the receiving portions 23A arranged in the end regions (AR2) is smaller than the distance L1 between the receiving portions 23A arranged in the central area (AR1). That is, although the receiving portions 23A arranged in the central region (AR1) are connected by the hinge portion 28 having a configuration same as that of the outer shape member in the first embodiment, the receiving portions 23A arranged in the left and right end regions (AR2) are connected by another hinge portion 29. The other hinge portion 29 has a basic structure substantially same as the hinge portion 28 (a first connection portion member 29a, a second connection member 29b and a hinge member 29c), but has a smaller dimension in the left-right direction than that of the hinge portion 28. Therefore, in the end areas (AR2), the receiving portions 23A are arranged relatively densely, and arrangement relationship thereof can be finely changed. In this way, in the seating surface portion SS illustrated in FIG. 14, the outer shape of the seating surface portion SS can be appropriately adapted to the occupants by finely changing the outer shape of the end areas (AR2) in accordance with the physiques of the occupants CM, CM1 and CM2. Therefore, according to the embodiment, the outer shape of the seating surface portion SS (the contact portion) that in contact with the occupant (the human body) can be finely changed by a simpler and more compact configuration.

The vehicle seat 2 (a vehicle interior equipment) of the embodiment is not limited to the above-described embodiment, and various other embodiments may be adopted. The embodiment illustrates a configuration (shape, dimension, arrangement position, arrangement number, components and the like) of the outer shape members 20 and 20A, but the disclosure is not intended to limit the configuration of the outer shape members. For example, in addition to a case where the outer shape member is arranged in the seat width direction, the outer shape member may be arranged in a direction (for example, the front-rear direction) intersecting the seat width direction. A grid-shaped member may be used as the outer shape member in addition to a member elongated in one direction. For example, in the outer shape member used for a seat cushion, the receiving portions may be connected (in a grid shape) by the hinge portions in the left-right direction and the front-rear direction. The configuration of each embodiment and the configuration of each modification can be appropriately replaced or combined. In addition, the cushion portions may be provided in all or part of the plurality of receiving portions, and may be omitted as necessary.

In addition to a configuration using three plate portions and the pillar portions, the receiving portion can adopt various shapes capable of attaching the hinge portion and the deformable portions, and a member having a columnar shape as a whole can also be used. The hinge portion may use various kinds of hinge-like members, and may be biased in one direction by a biasing member such as a spring. In a case where the material of the outer shape member is a resin, the receiving portion and the hinge portion may be integrally formed, and in this case, the hinge portion may be formed in an integral hinge shape. The hinge member of the hinge portion may be arranged to face the upper side (a side facing the human body). A polygonal shape such as a triangle or a hexagon, or a circular shape such as a circle or an oval can be adopted as the outer shape of the receiving portion in addition to a quadrangle as view from above. In a case of using a plurality of receiving portions, the outer shape and dimensions can be independently set. The receiving portion or the like may be formed of a material having electroconductivity (for example, metal or bio-metal), and may be used as an electrode for supplying power to a wire or a surface member.

The embodiment illustrates the deformable portions 30 and 32 including the wires or the surface member, but the configuration of the deformable portions is not intended to be limited. For example, the outer side deformable portion and the inner side deformable portion may each include at least one of the wires and the surface member. Each deformable portion may include another soft actuator that can be used as an alternative to the wires or the surface member, or may be used in combination with the wires or the surface member. Examples of such the other soft actuators may include a member made of a conductive polymer (a member in which an electrolyte is sandwiched between electrodes), a member made of an ionic polymer metal compound (a member in which a metal electrode is joined to a polymer electrolyte membrane swollen with water), a member made of an ionic polymer gel (a member that is extended by changing from acidic to alkaline (or vice versa)), and a member made of a magnetic active polymer (a magnetically moving member). The external stimulation can be appropriately set according to the kind of the soft actuator to be used, and two or more kinds of external stimulation can also be used.

The embodiment illustrates the vehicle seat 2 as a vehicle interior equipment, but the configuration of the embodiment can be applied to a contact portion of various vehicle interior equipment. Examples of such a vehicle interior equipment may include various members such as a door portion, an instrument panel, a ceiling portion and a console in addition to the vehicle seat, and the configuration of the embodiment can be appropriately applied particularly to a vehicle interior equipment mounted on a vehicle such as an automobile, an airplane, a train or a ship. A vehicle interior environment suitable for a specific occupant can be formed by changing the outer shape of the vehicle interior equipment (the contact portion) in accordance with the occupant. In the vehicle seat, in various seat components such as the seat back, the headrest and the armrest in addition to the seat cushion, the configuration of the embodiment can be applied to a portion constituting the seating surface portions and a portion constituting a design surface.

What is claimed is:

1. A vehicle interior equipment comprising:
a contact portion configured to contact with a human body; and
an outer shape member forming an outer shape of the contact portion, wherein the outer shape of the contact portion is configured to be changed by deforming at least a portion of the outer shape member, the outer shape member including:
a plurality of receiving portions capable of receiving the human body;
a hinge portion that connects adjacent receiving portions;
an outer side deformable portion arranged outward than the hinge portion on an outer side, the outer side being a side of the outer shape member facing the human body; and
an inner side deformable portion arranged inward than the hinge portion on an inner side opposite to the outer side,
wherein the plurality of receiving portions and the hinge portion constitute a frame of the outer shape member, and each of the outer side deformable portion and the inner side deformable portion is a linear or planar portion that is configured to be extended or contracted by external stimulation and is configured to return to an original state by not receiving external stimulation,
wherein the adjacent receiving portions are connected by the outer side deformable portion and the inner side deformable portion,
wherein a shape of the outer shape member and a shape of the contact portion are configured to be changed to the following (a) by the contraction of the outer side deformable portion or the extension of the inner side deformable portion that receives the external simulation, and are configured to be changed to the following (b) by the extension of the outer side deformable portion or the contraction of the inner side deformable portion that receives the external simulation:
(a) the outer shape of the contact portion being made concave by bending the hinge portion so that the adjacent receiving portions are close to each other on the outer side; and
(b) the outer shape of the contact portion being made convex by bending the hinge portion in an opposite direction so that the adjacent receiving portions are close to each other on the inner side, and
wherein the inner side deformable portion or the outer side deformable portion which is in a contraction state or an extension state is configured to maintain the changed outer shape of the contact portion even without contacting with the human body.

2. The vehicle interior equipment according to claim 1,
wherein each of the outer side deformable portion and the inner side deformable portion includes at least one of a wire configured to be extended or contracted upon receiving the external stimulation and a surface member configured to spread in a planar direction upon receiving the external stimulation.

3. The vehicle interior equipment according to claim 1,
wherein at least one of the outer side deformable portion and the inner side deformable portion includes a surface member configured to spread in a planar direction upon receiving the external stimulation, and
wherein the surface member is made of a dielectric elastomer.

4. The vehicle interior equipment according to claim 1,
wherein the hinge portion is made of metal, the hinge portion including:
a plate-shaped first connection member;
a plate-shaped second connection member; and
a hinge member that bendably connects the first connection member and the second connection member, and
wherein the first connection member is fixed to one of the adjacent receiving portions, and the second connection member is fixed to the other of the adjacent receiving portions.

5. The vehicle interior equipment according to claim 1,
wherein a cushion portion that is elastically stretchable is provided to a portion of each of the plurality of receiving portions facing the human body.
